(19) United States
(12) Patent Application Publication
(10) Pub. No.: US 2003/0101462 A1
(43) Pub. Date: May 29, 2003

(54) Control method of broadcasting system using a telephone and control device thereof

(76) Inventor: Soo Young Chung, Boopyung-ku (KR)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/278,881

(22) Filed: Oct. 24, 2002

(30) Foreign Application Priority Data
Oct. 26, 2001 (KR) 2001-66465

(51) Int. Cl. H04N 7/173; H04M 3/00; H04Q 7/20; H04M 1/00; H04B 1/38

(52) U.S. Cl. 725/106; 455/454; 455/420; 455/418; 455/557; 725/122

(57) ABSTRACT

The present invention relates to a control method of broadcasting system using a telephone and control device thereof The method comprises the steps of: connecting to a tone detector of the control system by switching a hook switch when a bell signal transmitted by a call of the subscriber is detected more than a set number; after the connection step, sending a previously recorded guidance voice to the subscriber under control of a central processing unit and detecting telephone button signals generated by a manipulation of the subscriber by frequency values of tone frequency; determining which broadcast region the subscriber wants based on the telephone button signals and driving corresponding relays; and connecting electrically the broadcasting system to a broadcast destination of the selected broadcast region to broadcast speech signals to the broadcast destination, the speech signals being sent from the subscriber. A control device comprises: a bell signal detector (20) connected to a telephone line (10) for detecting bell signals that ring by a set number; a central processing unit (50) for, upon receiving signals applied from the bell signal detector (20), switching a hook switch (K6) so that values of tone frequencies are applied and guidance voice is outputted simultaneously; a tone detector (30) for detecting the tone frequencies of telephone buttons and applying the detected tone frequencies to the central processing unit (50) in binary code form; a broadcast equipment controller (60) for receiving binary values from the tone detector (30) and supplying a power to a broadcast equipment to maintain broadcasting state; and an output controller (70) for receiving the binary values from the tone detector (30), determining locations of broadcast destinations and driving relays.

### BACKGROUND OF THE INVENTION

1. Field of the Invention

The present invention relates to a control method of broadcasting system using a telephone and control device thereof, and more particularly, to a control method of broadcasting system in which controlling a small-sized broadcasting system is allowed by using a telephone, thereby enabling to perform an easier and desired broadcasting without expert knowledge, and control device thereof.

2. Background of the Prior Art

In case of large-scaled broadcast systems, especially for parking lots or department stores, the systems are run under the control of some experts in the broadcasting fields. However, in case of small-scaled broadcast systems, especially for companies or schools, it is not allowed to employ such experts in the broadcasting fields and thus the employees of the companies or schools have to run the broadcast systems additionally besides their inherent affairs. Thus, in case some employees do their works and run the broadcast systems additionally, the broadcasting cannot be done at the right time the employees do their own work. For instance, in case of schools, the broadcast system cannot run when the teacher who is charge of the broadcast system is teaching student in a classroom if other teachers cannot run the broadcast system.

In particular, since the broadcast systems are so complicated that they have a plurality of control devices for amplifiers and microphones, and a plurality of switches to select the broadcast destinations, it is necessary for an operator to exactly perceive characteristics of the respective devices and locations of the broadcasting destinations. To this end, in most of broadcasting systems, expert operators are charge of such jobs.

### SUMMARY OF THE INVENTION

Accordingly, the present invention is directed to a control method of a broadcasting system using a telephone and control device thereof that substantially obviate one or more problems due to limitations and disadvantages of the related art.

It is an object of the present invention to provide a control method of a broadcasting system using a telephone and control device thereof which have a control device to control interconnection between the broadcasting system and a telephone line and allow to select the desired programs and broadcast destinations thereby to apply to the small-scaled broadcast systems easily.

It is another object of the present invention to provide a control method of broadcasting system using a telephone and control device thereof, which allows anybody to be guided through the telephone line and control the broadcasting systems to easily transmit the desired program to the desired broadcast destination.

It is another object of the present invention to provide a control method of broadcasting system using a telephone and control device thereof which are so applicable to small-sized broadcasting systems that users can simply drive them and easily select the multiple broadcast destinations.

In order to accomplish the above objects, the present invention provides a method of controlling a broadcasting system by a subscriber's telephone at a remote position using a control system installed between the subscriber's telephone and the broadcasting system, the method comprising the steps of: (a) connecting to a tone detector of the control system by switching a hook switch when a bell signal transmitted by a call of the subscriber is detected more than a set number; (b) after the connection step (a), sending a previously recorded guidance voice to the subscriber under control of a central processing unit and detecting telephone button signals generated by a manipulation of the subscriber by frequency values of tone frequency; (c) determining which broadcast region the subscriber wants based on the telephone button signals and driving corresponding relays; and (d) connecting electrically the broadcasting system to a broadcast destination of the selected broadcast region to broadcast speech signals to the broadcast destination, the speech signals being sent from the subscriber.

Each of broadcast output routines driven when determining the broadcast destination in the step (c) has a start button “*” and a end button “#”. The start button “*” is driven when broadcasting starts. The end button “*” is driven when broadcasting ends.

Each of broadcast ending methods includes ending a broadcast by detecting a telephone disconnecting sound when the telephone is disconnected, and determining a plurality of broadcast destinations besides pushing the end button “#”.

A control device installed between subscriber's telephone and a broadcasting system for controlling the broadcasting system using a telephone at remote position, comprises: a bell signal detector connected to a telephone line for detecting bell signals that ring by a set number; a central processing unit for, upon receiving signals applied from the bell signal detector, switching a hook switch so that values of tone frequencies are applied and guidance voice is outputted simultaneously; a tone detector for detecting the tone frequencies of telephone buttons and applying the detected tone frequencies to the central processing unit in binary code form; a broadcast equipment controller for receiving binary values from the tone detector and supplying a power to a broadcast equipment to maintain broadcasting state; and an output controller for receiving the binary values from the tone detector, determining locations of broadcast destinations and driving relays.

The central processing unit includes: a microprocessor for controlling operation of the central processing unit; a reset unit including a reset switch, a diode for removing ripples, and a condenser; an oscillator unit including a crystal oscillator, condensers and a resistor; and a transistor for controlling a hook switch.

The tone detector in which the hook switch operates in an off mode is connected to a phototransistor via a contact point of the hook switch and is configured to apply an output of the phototransistor to the microprocessor via a transistor. The information messaging unit is configured to be connected to a transformer via the telephone line and connected to the microprocessor via Zener diodes, condensers and a resistor so that the information speech is outputted and simultaneously the information messaging unit is connected to the broadcast equipment controller to process audio signals.

It is to be understood that both the foregoing general description and the following detailed description of the present invention are exemplary and explanatory and are intended to provide further explanation of the present invention as claimed.

### BRIEF DESCRIPTION OF THE DRAWINGS

The accompanying drawings, which are included to provide a further understanding of the present invention and are incorporated in and constitute a part of this application, illustrate embodiments of the present invention and together with the description serve to explain the principle of the present invention. In the drawings:

FIG. 1 is a bock diagram showing a broadcasting system using a telephone in accordance with the present invention;

FIG. 2 is an exemplary circuit of the block diagram of FIG. 1; and

FIG. 3 is a flow chart showing a driving relation of the present invention sequentially.

### DETAILED DESCRIPTION OF THE PREFERRED EMBODIMENTS

Reference will now be made in detail to a preferred embodiment of the present invention with accompanied drawings.

The present invention can be applied to broadcast systems of parking lots, department stores, small-sized companies and school. For convenience, the description will be made usually with the example of the broadcast system of schools.

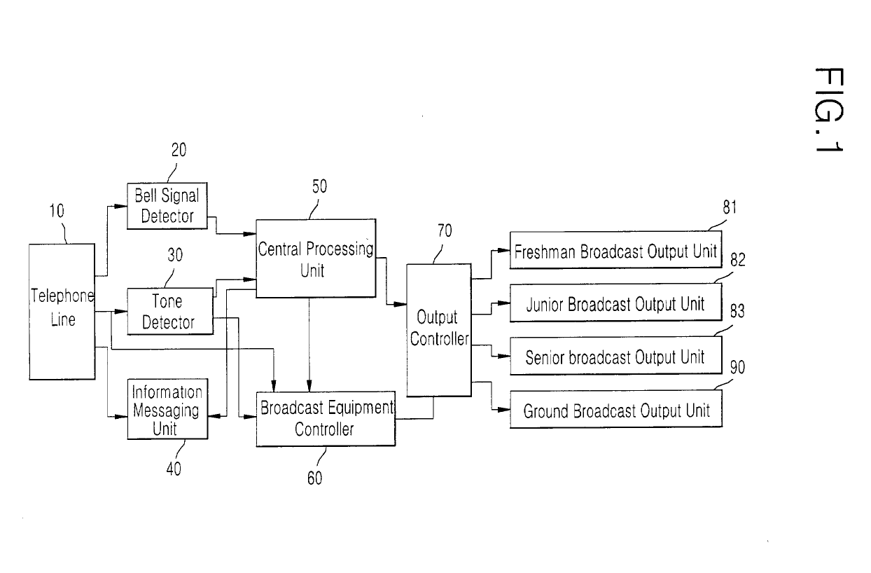

FIG. 1 is a bock diagram showing a broadcasting control system according to the present invention. Referring to FIG. 1, it is obvious to the people skilled in the related art that usually the main system of the present invention includes general telephone circuit and broadcasting system basically. The control device of the present invention is provided between the general telephone circuit and the broadcasting system. The user operates the control device through the telephone circuit and the control device operated by the user controls the broadcast system.

In other words, the telephone line 10 is connected to general telephones. The ringing signals sent to the telephone line 10 are applied to a central processing unit 50 through ringing signal detector 20. The frequency signals (the frequency signals generated when buttons of a telephone are pushed) sent through the telephone 10 are applied to the central processing unit 50.

The central processing unit 50 is connected to the telephone line 50 through the information messaging unit to transmit information message. The central processing unit 50 controls a broadcasting system controller (60) and a output controller 70 to output the audio signals inputted from the telephone line through a freshman broadcast output unit 81, a junior broadcast output unit 82, a senior broadcast output unit 83 or a ground broadcast output unit 90.

The mechanism of the device of the present invention is described. When a subscriber calls by his or her telephone (not shown in FIG. 1) externally, the ringing signal detector 20 detects the ringing signals applied from the telephone. If the ringing signal detector 20 detects the ringing signals by a predetermined times, the central processing unit 50 holds the telephone in an off-hook state and at the same time connects a tone detector 30 to the telephone line 10 to transmit information speech to a caller. The caller listens to the information speech sent from the central processing unit 50 and pushes the telephone buttons to broadcast to the desired broadcast destination using the telephone externally.

In other words, if the caller select the desired broadcast by pushing the telephone buttons according to information speech, the tone detector 30 detects telephone button signals and applies them to the central processing unit 50 and the central processing unit 50 controls the broadcast system controller 60 and the output controller 70 to output the audio signals sent from the telephone line to the desired region through the broadcast output units 81 to 83 and 90.

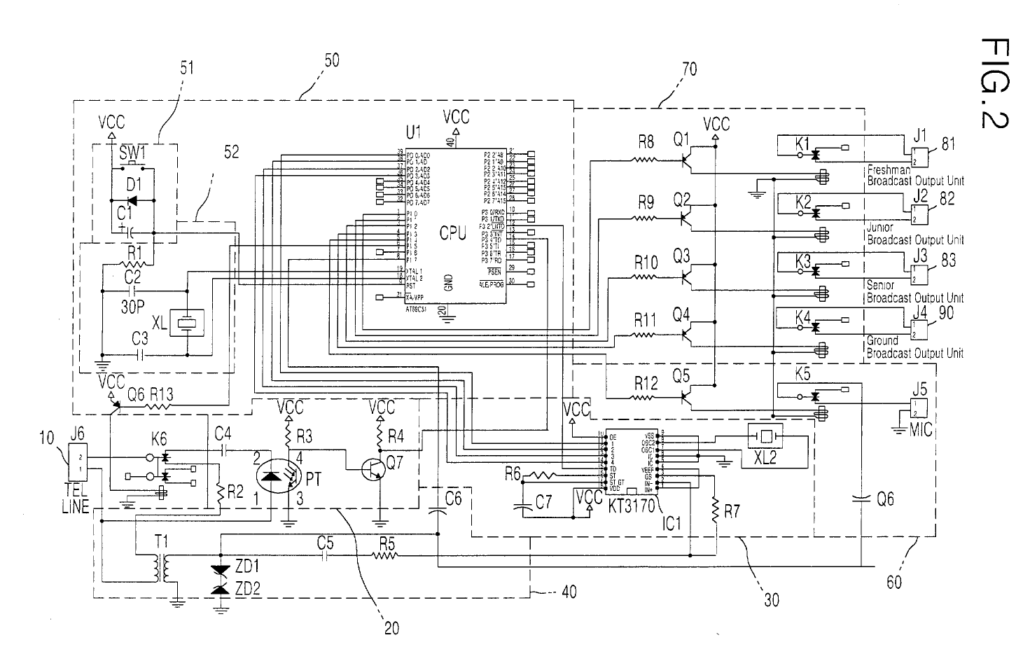

More detailed description is made with FIG. 2. FIG. 2 is a detailed embodiment circuit of a broadcasting system using a telephone depicted in FIG. 1.

Referring to FIG. 2, the central processing unit 50 includes a microprocessor CPU, a reset unit 51, an oscillator unit 52 and a transistor Q6 for controlling a hook switch K6 of the telephone. The reset unit 51 includes a reset switch SW1, a diode D1 for removing ripples, and a condenser C1. The oscillator unit 52 includes a crystal oscillator XL, condensers C1 and C2 and a resistor R1. The condensers and the resistor are used to set time constant.

Specifically, the microprocessor CPU of the central processing unit 50 is an AT89C52 integrated circuit and has the characteristics as follows:

a 8 KB EPROM (Erasable Programmable Read Only Memory) embedded

a 256-byte internal RAM (Random Access Memory) embedded

two 16-bit timers that can be used in 4 modes and a counter embedded

a serial port that can be used in I/O (Input/Output) expansion mode or UART mode

four interrupt functions in which priority can be set

clock oscillator embedded

8 KB internal program memory embedded.

64 KB external program memory address area included

wide Boolean commend included

The ringing signal detector 20 is connected through the hook switch K6, includes a bypass condenser C4, a phototransistor PT and a transistor Q7 which receives the output of the phototransistor PT and is driven, and applies ringing signals to a microprocessor CPU.

In this embodiment of the present invention, the microprocessor CPU switches into an off-hook mode after a telephone rings by a predetermined times.

The information messaging unit 40 is an audio signal processor and is connected to a telephone line 10 and output terminals of the microprocessor CPU of a central processing unit 50. Especially the information messaging unit 40 is connected electrically to the microprocessor CPU through AC bypass condensers C5 and C6 to which Zener diodes ZD1 and ZD2 are connected through a transformer T1.

When buttons of a telephone are pushed, the tone detector 30 which detects the pushed button numbers receives signals through the contact of the hook switch K6 during hook switch is off. The received signals are applied to the microprocessor CPU through a tone integrated circuit IC1. In this case, a resistor R6 and a condenser C7 is to protect the integrated circuit and XL2 is crystal oscillator.

A broadcasting system controller 60 operated under the control of the microprocessor CPU is configured so that the output of the microprocessor CPU is applied to the terminals of a microphone J5 through a transistor Q5 and a relay K5.

A output control unit 70 which receives the output of the microprocessor CPU and is operated includes transistors Q1 to Q4 and relays K1 to K4 and is connected electrically to broadcast output units 81 to 83 and ground broadcast output unit 90. The broadcast output units 81 to 83 are a freshman broadcast output units 81, a junior broadcast output units 82 and a senior broadcast output units 83. Each of the broadcast output units 81 to 83 includes speakers and is closed-circuited with a broadcasting room.

The present invention is described on condition that the broadcasting system is equipped. The detailed description will be made with the example of the broadcasting system in schools.

In the present invention, it is assumed that the broadcast output units 81 to 83 are equipped with speakers and installed in each classroom and the ground broadcast output unit 90 is equipped with speakers and is installed on the ground of a school. It is also assumed that the outputs of microphones of the broadcast are connected by either jack connectors or relays. In case of the present invention, the relays are used rather than the jack connectors in connecting to the desired classroom or the ground for the sake of automatic control.

In the control system of the present invention, the central processing unit 50 connects an external telephone to the broadcasting system. The characteristics of the general telephones and the characteristics of ringing signal detectors 20 and tone detectors 30 is disclosed hereafter.

1. The characteristics of the telephone lines of Korea and ITU-T (International Telecommunication Union—Telecommunication Standards Section)

1) Waiting (On hook): substantially DC 48 V (Polarities depend on connection.)

2) Ringing: substantially AC 90 V (16≠20 Hz)

3) Connection (Off hook): substantially DC 18 V (The polarities of DC 48 V on hook are inversed.)

4) Termination (On hook): substantially DC 48 V (The polarities of connection are inversed.)

5) Signal sound analysis

| | | | Classes | |
|---|---|---|---|---|
| Signals | | | ITU-T Recommendation | Korea Standard |
| Transmission | Frequency | Single | 400 ˜ 450 | None |
| sound | (Hz) | Complex | 340 ˜ 425 + 400 ˜ 425 | 350 + 440 |

| | | | |
|---|---|---|---|
| | Ringing period (seconds) | Continued | Continued |
| Ringing sound | Frequency (Hz) | 400 ˜ 450 | 440 + 480 |
| | Ringing period (seconds) | Ringing: 0.67 ˜ 1.5 | Ringing: 1 |
| | | Mute: 3 ˜ 5 | Mute: 2 |
| Telling sound | Frequency (Hz) | 400 ˜ 450 | 480 + 620 |
| | Ringing period (seconds) | Ringing + Mute: 1.1 | Ringing: 0.5 |
| | | Ringing / Mute 0.67 ˜ | Mute 0.5 |
| | | 1.5 | |
| Reckless sound | Frequency (Hz) | 400 ˜ 450 | 480 + 620 |
| | Ringing period (seconds) | Ringing + Mute: 1.1 | Ringing: 0.3 |
| | | Ringing / Mute: 0.67 ˜ | Mute: 0.2 |
| | | 1.5 | |
| Ringing signals | Frequency (Hz) | Depends on each state | 20 |
| | Ringing period (seconds) | Same as the ringing | Ringing: 1 |
| | | sound | Mute: 1 |

2. The characteristics of the ringing signal detector 20

It detects ringing signals that ring 20 times a second by 3 times (20 times×3 times=60 times) and transmits them to the microprocessor CPU.

3. The characteristics of the tone detector 30

1) Analysis of dual tone multiple frequencies of tone detector 30

When the number buttons are pushed, dual tone multiple frequencies (DTMF) are generated. An exchanger exchanges telephone calls using the DTMF. The tone detector detects the DTMF signals and converts them into binary codes (at integrated circuit KT3170). The digitally converted DTMF signals are used as control signals to control the microprocessor.

| | | High Frequencies | | | |
|---|---|---|---|---|---|
| | | 1209 Hz | 1336 Hz | 1477 Hz | 1633 Hz |
| Low | 697 Hz | 1 | 2 | 3 | A |
| frequencies | 770 Hz | 4 | 5 | 6 | B |
| | 852 Hz | 7 | 8 | 9 | C |
| | 941 Hz | * | 0 | # | D |

* A, B, C and D are reserved signals, and are used now.

Example) When the number button “1” is pushed, two signals of 697 Hz and 1209 Hz are generated at the same time.

2) The functions of a tone decoder

The tone decoder IC (KT3170) receives the DTMF signals generated when the number buttons of a telephone are pushed, and converts them into binary codes. The digitally converted binary codes are used as control signals by the microprocessor to manipulate password and operate relays of control units. The conversion rule is as the followings.

Output Data

| Number | Q4 | Q3 | Q2 | Q1 |
|---|---|---|---|---|
| 1 | 0 | 0 | 0 | 1 |
| 2 | 0 | 0 | 1 | 0 |
| 3 | 0 | 0 | 1 | 1 |
| 4 | 0 | 1 | 0 | 0 |
| 5 | 0 | 1 | 0 | 1 |
| 6 | 0 | 1 | 1 | 0 |
| 7 | 0 | 1 | 1 | 1 |
| 8 | 1 | 0 | 0 | 0 |
| 9 | 1 | 0 | 0 | 1 |
| 0 | i | 0 | 1 | 0 |
| * | 1 | 0 | 1 | 1 |
| # | 1 | 1 | 0 | 0 |
| A | 1 | 1 | 0 | 1 |
| B | 1 | 1 | 1 | 0 |
| C | 1 | 1 | 1 | 1 |
| D | 0 | 0 | 0 | 0 |

Comment: “0”: 0 V (Ground), “1”: +5 V.

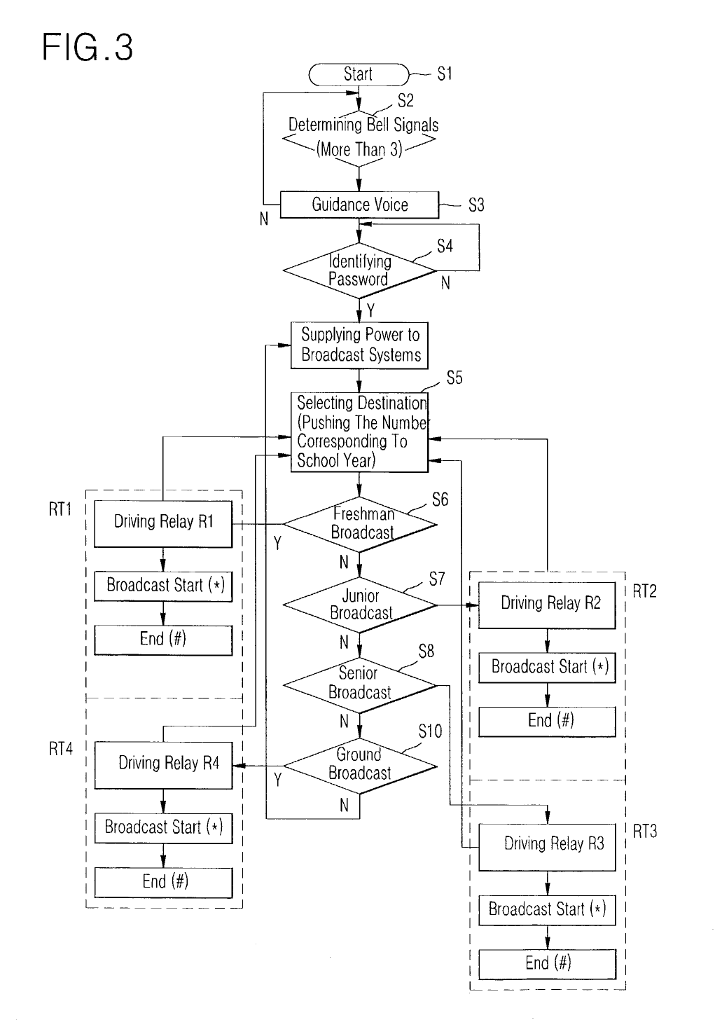

The present invention described above will be explained in detail with reference to the flow chart of FIG. 3.

The operation consists of three steps, i.e. the step of identifying a password, the step of selecting broadcast destination using the signal of tone frequencies after identification of the password and the step of connecting the broadcast destination and a telephone.

First, at step S1, as soon as power-on, troubles are checked and normal operation is maintained.

When a user wants to broadcast (described with school broadcast), the user call a phone to a broadcasting room (step S 2). In this time, the telephone rings a predetermined times, the central processing unit 50 makes hook switch K6 be off and keep connection with the telephone. In other words, when the telephone rings, the hook switch is on and the ringing signals are applied to the ringing signal detector 20 as shown in FIG. 2. The ringing signal detector 20 turn on a phototransistor PT and the transistor Q7 connected to the phototransistor PT is turned on by the phototransistor PT. The collector of the transistor Q7 goes into low voltage state. The microprocessor CPU detects the signal generated at the collector of the transistor Q7. In other words, the ringing signal detector 20 detects the ringing signal that rings 20 times a second by a predetermined times. The telephone is maintained off hook and the telephone line is switched to the tone detector 30. The microprocessor CPU turns on a transistor Q6 and excites the relays to switch a hook switch.

The central processing unit 50 transmits information speech to the caller while the telephone line is connected. The output signal of the microprocessor CPU is outputted as the predetermined information speech through the condenser C6 of the information messaging unit 40, the transformer T1 and the telephone line at the step S3. In other words, when the user calls the broadcasting room, it gets into the hook-off state and the following information speech is outputted through the receiver of the caller for about 40 seconds by the information messaging unit 40. If the information is not necessary to the caller, the caller can manipulate the telephone buttons to skip the information speech so that the information speech is cancelled automatically and the user can broadcast. The information message is as follows and can be changed.

“Hello?”

“This is telephone broadcasting system of ◯◯ school.”

“Enter 4-digit password. The number 1 is for freshman broadcast, the number 2 is for junior broadcast, the number 3 is for senior broadcast, and the number 4 is for ground broadcast. Push the number you want to broadcast to, push asterisk “*” to start your broadcasting and push sharp “#” to end your broadcasting.”

“Have a nice day!”

After the information messages are sent, the microprocessor CPU wait for the button signal the caller sent through the tone detector 30. When the caller manipulates, the buttons the tone detector 30 compares the inputted binary code and transmits to the broadcasting system the speech signals sent through the telephone line if the password is identified at the step S5.

In other words, the frequencies of tone pulses sent through the telephone line 20 are the frequencies of the buttons (cf. the above table). If these signals are applied to the tone integrated circuit IC1 through the transformer T1, the tone integrated circuit IC1 outputs the corresponding binary signal to the microprocessor CPU to identify a password. When the password is identified at the step S5, the broadcasting systems get ready to broadcast and the microprocessor CPU operates the broadcasting system controller 60. In other words, the output of the microprocessor CPU drives a transistor Q5 to connect to the relay K5 so that microphones are connected and amplifiers get ready at the same time.

At step S6, the user selects the desired broadcast destination such as a freshman broadcast output unit, a junior broadcast output unit, a senior broadcast output unit or ground broadcast output unit. The caller pushes the telephone buttons according to the information speech outputted from the receiver. The button signals are inputted to the microprocessor CPU through the tone detector 30. The microprocessor CPU selects the broadcast destination at the steps S7, to S10. For example, if a freshman broadcast output unit is selected, determination is performed at the step S6 and routine RT1 is performed. In the other words, the microprocessor CPU drive a relay K1 to select the freshman broadcast output unit 81 so that the speech signal of the caller inputted from a microphone MIC is outputted through a speaker. Then the broadcasting system is initialized if the broadcast termination signal “#” is inputted or the telephone is connected. The output controller 70 uses transistors Q1 to Q4 to control the current that flows on the coil of the relay. Relay switches are connected to the speaker switches and polarity relays is used as the relays to control the great amount of current.

In other words, the microprocessor CPU drives the corresponding relays if the tone detector identifies the telephone button signals as follows:

* For example school year to broadcast: 1 to 4 (expandable)

### EXAMPLE

Button “1”: a freshman broadcasting selected: the relay K1 driven

Button “2”: a junior broadcasting selected: the relay K2 driven

Button “3”: a senior broadcasting selected: the relay K3 driven

Button “4”: a ground broadcasting selected: the relay K4 driven

* When canceling the previously pushed broadcast number, push “number 0” and the previous selection will be cancelled. When the operation is completed, the sound “beep” is outputted from the receiver.

In this way, the desired broadcast destination (location to be broadcasted) is selected by pushing buttons at the steps S7 to S10 and the routines RT1 to RT4 corresponding to the steps S7 to S10 respectively are performed to broadcast. Each of the routines RT1 to RT4 includes the start button “*” to determine to start when stating the broadcasting at the corresponding step, the end button “#” to determine to end when ending the broadcasting at the corresponding step and the step to detect the disconnection sound to perform them. In other words, for example, in case the routine RT1 is selected, the step is performed that the relay R1 is driven to connect to a freshman broadcast output unit 81. When the button “*” is pushed, the broadcast starts. When the button “#” is pushed, the broadcast ends after sending the confirmation sound “beep” to the receiver. When the user hooks on, the confirmation sound is sent, all the your broadcasting programs end and the broadcast systems are turned off. Similarly, the remaining routines RT2 to RT4 also excite the corresponding relays and perform of the functions of the start button “*” and the end button “#” to start and end your broadcasting.

Referring to FIG. 3, performed is the step S1 at which power is applied to the broadcast system. At the step S6, the broadcast destination is then selected and the button corresponding to the school year to be broadcast to is pushed to detect the state that is always inputted to the step S6 after driving. Even after selecting a freshman broadcast, the routine RT is performed to allow the user to push the telephone buttons to select the routines RT1 to RT4 for other school years and start the your broadcasting by pushing the start button “*”

In the same way, in case of selecting the multiple broadcast destinations, all the your broadcasting programs are terminated at the same time if the end button “#” or a user hook on. This is called program termination method.

The present invention provides the device to transmit the continuous signals (speech, music, English listening comprehension test, etc) using general audio goods (cassette recorders, CD players, radios and so on) in an office without going to the broadcasting room. The present invention is very easy to apply to small-sized broadcasting systems.

According to the above description, the present invention makes it possible that small-sized broadcasting system is run remotely without any special broadcast operators. The device and method of the present invention detect the ringing signal applied through the telephone line to connect to a tone detector, and identify a password inputted to the tone detector. And also, the microprocessor of the broadcasting system of the present invention connects the amplifiers of the broadcast room to the speaker corresponding to the broadcast destination through the broadcasting system controller and the output controller. The user can broadcast the desired broadcast programs using telephones.

For example, in case not only the broadcast for education but also the emergency occurs, the broadcasting system is controlled using a mobile telephone at the current places or safe places so that the information announcement for safe exit, etc. can be performed. Especially, it is easy to use since the control by a telephone can be performed with wire or wirelessly. It is not required that the user should learn the expert technology. The present invention allows us to use the conventional broadcasting systems to construct the broadcasting system that can be controlled by telephone. The present invention is suitable for the small-sized broadcast systems that are not allowed to employ expert broadcast operators.

Even though it is described with respect to school broadcasting systems herein, it is noted that it is applicable to the broadcasting systems for parking lots, small-sized companies, fire-fighting emergency telephone equipment, etc. without a lot of modification.

The forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of controlling a broadcasting system by a subscriber's telephone at a remote position using a control system installed between the subscriber's telephone and the broadcasting system, the method comprising the steps of:
(a) connecting to a tone detector of the control system by switching a hook switch when a bell signal transmitted by a call of the subscriber is detected more than a set number;
(b) after the connection step (a), sending a previously recorded guidance voice to the subscriber under control of a central processing unit and detecting telephone button signals generated by a manipulation of the subscriber by frequency values of tone frequency;
(c) determining which broadcast region the subscriber wants based on the telephone button signals and driving corresponding relays; and
(d) connecting electrically the broadcasting system to a broadcast destination of the selected broadcast region to broadcast speech signals to the broadcast destination, the speech signals being sent from the subscriber.

2. The method as claimed in claim 1, wherein each of broadcast output routines driven when determining the broadcast destination in the step (c) has a start button “*” and an end button “#”, the start button “*” being driven when broadcasting starts, the end button “*” being driven when broadcasting ends,
wherein the step (c) includes the step of ending a broadcast by detecting a telephone disconnecting sound when the telephone is disconnected.

3. The method as claimed in claim 1 or 2, further comprising the steps of:
(e) after determining the broadcast region, terminating simultaneously all programs that detect the end button “#” and the telephone disconnecting sound, the end button “#” being driven when ending the broadcasting, the telephone disconnecting sound being generated when the telephone is disconnected; and
(f) selecting a plurality of broadcast destinations to broadcast, ending the broadcasting and turning off the broadcast device.

4. A control device installed between subscriber's telephone and a broadcasting system for controlling the broadcasting system using a telephone at remote position, comprising:
a bell signal detector (20) connected to a telephone line (10) for detecting bell signals that ring by a set number;
a central processing unit (50) for, upon receiving signals applied from the bell signal detector (20), switching a hook switch (K6) so that values of tone frequencies are applied and guidance voice is outputted simultaneously;
a tone detector (30) for detecting the tone frequencies of telephone buttons and applying the detected tone frequencies to the central processing unit (50) in binary code form;
a broadcast equipment controller (60) for receiving binary values from the tone detector (30) and supplying a power to a broadcast equipment to maintain broadcasting state; and
an output controller (70) for receiving the binary values from the tone detector (30), determining locations of broadcast destinations and driving relays.

5. The control device as claimed in claim 4, wherein the central processing unit (50) includes:
a microprocessor (CPU) for controlling operation of the central processing unit (50);
a reset unit (51) including a reset switch (SW1), a diode (DI) for removing ripples, and a condenser (C1);
an oscillator unit (52) including a crystal oscillator (XL), condensers (C1, C2) and a resistor (R1); and
a transistor (Q6) for controlling a hook switch (K6).

6. The control device as claimed in claim 5, wherein the tone detector (30) in which the hook switch (K6) operates in an off mode is connected to a phototransistor (PT) via a contact point of the hook switch (K6) and is configured to apply an output of the phototransistor (PT) to the microprocessor (CPU) via a transistor (Q7).

7. The control device as claimed in claim 5, wherein the information messaging unit (40) is configured to be connected to a transformer (T1) via the telephone line (10) and connected to the microprocessor (CPU) via Zener diodes (ZD1, ZD2), condensers (C5, C6) and a resistor (R5) so that the information speech is outputted and simultaneously the information messaging unit (40) is connected to the broadcast equipment controller (60) to process audio signals.
